(19) United States
(12) Patent Application Publication
(10) Pub. No.: US 2024/0377803 A1
(43) Pub. Date: Nov. 14, 2024

(54) TOOL CHUCK ARRANGEMENT FOR AVOIDING A BREAKAGE OF A PROCESSING FACILITY AND METHODS THEREOF

(71) Applicant: FRITECH IMPORT AND MARKETING LTD., Ginaton (IL)

(72) Inventor: Ilay Fridland, Ginaton (IL)

(21) Appl. No.: 18/377,244

(22) Filed: Oct. 5, 2023

(30) Foreign Application Priority Data
May 10, 2023 (IL) 302835

(51) Int. Cl. G05B 19/402; B23Q 15/12

(52) U.S. Cl. CPC G05B 19/402; B23Q 15/12; G05B 2219/33099; G05B 2219/37237

(57) ABSTRACT

A computer numerical control machine has a power head and a tool holder rotatable coupled to the power head. A collision sensor issues a collision signal upon detecting a collision of the tool holder with an object. The collision sensor may be in the form of thermometer measuring the temperature of the tool holder, a light sensor detecting proximity of an object to the tool holder, or a protecting sleeve mounted onto the tool holder.

### RELATED APPLICATIONS

This application claims priority benefit from Israeli Patent Application, Ser. No. 302835, filed May 10, 2023, the disclosure of which is incorporated herein by reference in its entirety.

### FIELD

This document relates generally to the field of machining and, more particularly, to computerized machining system and tool chuck arrangement for avoiding or otherwise alarming at time of potential collision or breakage and to methods thereof.

### BACKGROUND

Highly sophisticated equipment controlled by computers, such as CNC (Computer Numerical Control) machines, operate to generate machined part according to preprogrammed computer instructions. Numerical control can be used to automate the operation of various production machines, such as drills, lathes, mills, grinders, routers, 3D printers, etc. These machines incorporate computer controlled motorized maneuverable tool, motorized maneuverable platform, or both. Generally the part to be manufactured is designed using computer aided design (CAD) software and then translated into manufacturing directives by computer-aided manufacturing (CAM) software. The actual manufacturing process involves continuous relative movement between the tool and the manufactured part, also referred to as the workpiece.

Much of the failure or non-compliance issues which arise in CNC machining often comes from programming. The errors in programming may result in disallowed relative movement between the tool and the workpiece and, potentially, in undesired collisions of the tool with obstacles, which often cause damage to the machine. Such errors may be exacerbated by two characteristics of modern CNC machines, i.e., the high spinning speed of the chuck or tool holder and the ability of the tool holder to automatically change tools during production. Notably, the high rotational speed may lead to serious machine damage upon collision, and any change of tool necessarily means that the amount the tool extends from the rotational axis of the tool holder also changed, which needs to be included when designating the safety margins for the relative motions. To clarify, a ⅞″ drill bit extends further from the rotational axis than a ⅜″ drill bit, such that the chuck must remain further away from an obstacle when holding a ⅞″ drill bit than when holding a ⅜′ drill bit.

For further background information, the reader is directed to, e.g., US2022339716. An apparatus and method for three-dimensional cutting of a multi-axis feature into a workpiece that are at least partially characterized by a lack of rotationally symmetrical tools and an ability to produce high aspect ratio (depth to diameter) features using mechanical machining are provided. The apparatus includes a base, a displaceable machine table supported on that base, a displaceable spindle supported on the base adjacent the machine table, a cutting tool held in a chuck carried on the spindle and a control module. The control module includes a controller and a plurality of actuators to provide precise displacement of the machine table, spindle, cutting tool and the workpiece for cutting multi-axis surface features into the workpiece. The motion of the multiple axes is computer-controlled to avoid collisions between the complex geometry of the cutting tool and the workpiece feature being machined.

Hence, there is a long-felt and unmet need for effective collision avoidance of computer-controlled machines.

### SUMMARY

The following summary of the disclosure is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

It is an aim of the present disclosure to overcome the problems identified above related to preventing collision and damage to computerized machining tools. In particular, it is an aim of the present invention to prevent any unintended collision and/or to alarm an operator of an imminent or potential collision.

In disclosed embodiments, a computer numerically controlled (CNC) machine is provided, comprising: a power head mounted on a base; a tool holder rotationally mounted onto the power head; a controller; a collision sensor monitoring the tool holder and issuing a collision signal to the controller indicating potential collision of the tool holder with an object. The collision sensor may be in the form of light sensor, temperature sensor, contact sensor, etc.

Aspects of the disclosure include a tool holder for a computer numerical control machine, comprising: a tool holder body having exterior surface, generally cylindrical; a sleeve mounted on the exterior cylindrical surface of the tool holder, the sleeve comprises a resilient insulation layer provided around the exterior cylindrical surface of the tool holder, and an exterior electrically conductive layer provided over (and generally concentric with) the resilient insulation layer; wherein the exterior electrically conductive layer is electrically-interconnected with a controller configured for stopping motion of the tool holder upon receiving a collision signal from the exterior electrically conductive layer. The tool holder may include a brush contact electrically contacting the exterior electrically conductive layer. Alternatively, the brush contact may be mounted onto a power head of the CNC machine and contact the exterior electrically conductive layer.

Other aspects include a sensor, e.g., a tool chuck protecting sleeve, characterized by a sleeve (sensor 30) mountable on a tool chuck (tool holder 10) configured for holding a milling cutter. The sleeve is having an internal portion facing the tool chuck and an opposite external portion (30A). The sleeve (30) comprises (a) a first, externally located, electrically insulating layer (301a); (b) a first electrically conductive layer (303a) provided in connection with the inner portion of the insulting layer (301a); (c) a resilient insulation layer (305a), provided in connection with the inner portion of the first electrically conductive layer (303a); and (d) a second electrically conductive layer (307), provided in connection with the inner portion of the resilient insulation layer (305a); and (e) a second electrically insulating layer (309), provided in connection with the inner portion of the second electrically conductive layer (307).

Another aspect is the tool chuck protecting sleeve being integrated or being able to integrate with the tool chuck (10).

A further aspect is a sensor, e.g., a tool chuck protecting sleeve system, characterized by: (a) a sleeve (30) mountable on a tool chuck (10) configured for holding an operator, e.g., a milling cutter. The sleeve is having an internal portion facing the tool chuck and an opposite external portion (30A); the sleeve (30) comprises (i) a first, externally located, electrically insulating layer (301a); (ii) a first electrically conductive layer (303a) provided in connection with the inner portion of the insulting layer (301a); (iii) a resilient insulation layer, provided in connection with the inner portion of the first electrically conductive layer (303a); (iv) a second electrically conductive layer (307), provided in connection with the inner portion of the resilient insulation layer (305a); and (v) a second electrically insulating layer (309), provided in connection with the inner portion of the second electrically conductive layer (307); and (b) a controller configured for stopping the processing facility; the controller is electrically-interconnected with either or both the first electrically conductive layer (303a) and the second electrically conductive layer (307).

An object is to disclose a tool holder, e.g., a chuck protecting sleeve system, characterized by: (a) a sleeve (30) mountable on a tool chuck (10) configured for holding an operation, e.g., a milling cutter. The sleeve is having an internal portion facing the tool chuck and an opposite external portion (30A); the sleeve (30) comprises (i) a first, externally located, electrically insulating layer (301a); (ii) a first electrically conductive layer (303a) provided in connection with the inner portion of the insulting layer (301a); (iii) a resilient insulation layer (305a), provided in connection with the inner portion of the first electrically conductive layer (303a); (iv) a second electrically conductive layer (307), provided in connection with the inner portion of the resilient insulation layer (305a); and (v) a second electrically insulating layer (309), provided in connection with the inner portion of the second electrically conductive layer (307); and (b) a controller configured for stopping the milling; the controller is electrically-interconnected with either or both the first electrically conductive layer and the second electrically conductive layer (307).

The controller is operatable in a method comprises steps as follows: (a) along a safe milling, the resilient insulation layer (305a) continuously insulating the first (303a) and second (307) electrically conductive layers from each other; and (b) upon an externally applied mechanical impact (40) provided via (1) the first electrically insulating layer (301a), (2) the first electrically conductive layer (303a), and (3) resilient insulation layer (305a), the first electrically conductive layer (303a) is connecting the second (307) electrically conductive layer; thereby closuring a circuit between the first and second electrically conductive layers and signaling interconnected controller for stopping the milling operation.

A further object is to disclose a method of alarming or otherwise avoiding a collision or the breakage of an object with the tool chuck operation; the method characterized by steps of providing tool chuck protecting sleeve system; characterized by (a) mounting or otherwise integrating a tool chuck (10) configured for holding a milling cutter with a tool chuck protecting sleeve (30) having an internal portion facing the tool chuck and an opposite external portion (30A); (b) by means of the milling cutter provided within a tool chuck protecting sleeve, safely milling; the resilient insulation layer (305a) continuously insulating the first (303a) and second (307) electrically conductive layers from each other; and (b) upon applying an externally mechanical impact (40) provided via the first electrically insulating layer (301a), (2) the first electrically conductive layer (303a), and (3) resilient insulation layer (305a), connecting the first electrically conductive layer (303a) with the second (307) electrically conductive layer; thereby closuring a circuit between the first and second electrically conductive layers and signaling interconnected controller for stopping the milling operation.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 illustrates an example of a numerically controlled machine incorporating a sensor according to an embodiment;

FIG. 2 is a schematic diagram of a tool chuck arrangement for avoiding a breakage of a processing facility;

FIG. 3A is a schematic diagram of a partial cross-section of a sleeve mounted onto a tool chuck in a normal position; and FIG. 3B is a schematic diagram of the cross-section of a sleeve mounted onto a tool chuck in a collision position;

FIGS. 3C-3F illustrate various embodiments of a resilient insulation layer;

FIG. 4 illustrates an example of a tool holder of a numerically controlled machine incorporating a proximity sensor according to an embodiment;

FIG. 5 illustrates another example of a numerically controlled machine incorporating a proximity sensor according to another embodiment;

FIG. 6 illustrates an example of a numerically controlled machine incorporating a collision sensor according to an embodiment, while FIG. 6A illustrate a cross-section of the collision sensor during normal operation and FIG. 6B illustrates a cross-section of the collision sensor during collision;

FIG. 7 illustrates an example of a numerically controlled machine incorporating a thermometer-based collision sensor according to an embodiment.

FIG. 8 illustrates an example of a numerically controlled machine incorporating a signal generator-based collision sensor according to an embodiment.

FIG. 9 illustrates an example of a collision sensor incorporating a signal generator according to an embodiment.

FIG. 10 illustrates an example of a collision sensor incorporating a proximity sensor according to an embodiment.

### DETAILED DESCRIPTION

The following description is provided, so as to enable any person skilled in the art to make use of said invention and sets forth the best modes contemplated by the inventor of carrying out this invention. Various modifications, however, are adapted to remain apparent to those skilled in the art, since the generic principles of the present invention have been defined specifically to provide a tool chuck arrangement for avoiding a breakage of a processing facility and a method of implementing the same.

Embodiments of the inventive computerized machining system and method will now be described with reference to the drawings. Different embodiments or their combinations may be used for different applications or to achieve different benefits. Depending on the outcome sought to be achieved, different features disclosed herein may be utilized partially or to their fullest, alone or in combination with other features, balancing advantages with requirements and constraints. Therefore, certain benefits will be highlighted with reference to different embodiments, but are not limited to the disclosed embodiments. That is, the features disclosed herein are not limited to the embodiment within which they are described, but may be “mixed and matched” with other features and incorporated in other embodiments, even if such are not explicitly described herein.

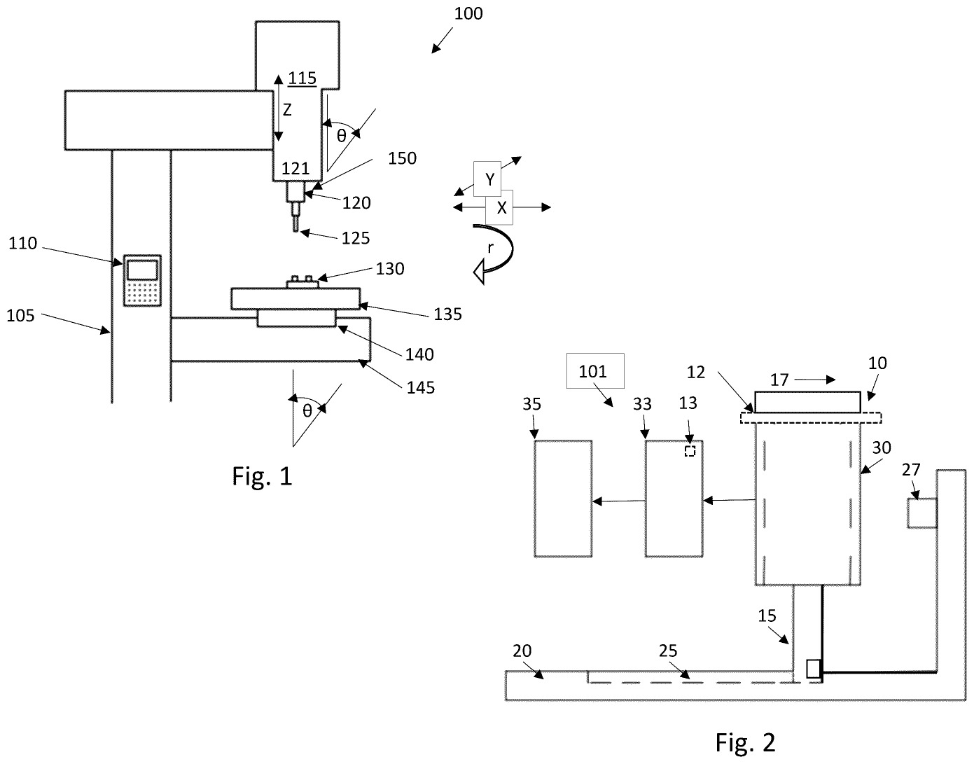

Reference is now made to FIG. 1, which illustrates an example of a numerically controlled machine incorporating a collision sensor according to an embodiment wherein the collision sensor is implemented as a contact sensor. Machine 100 has a column 105, which forms a base for mounting all parts of the machine. A machine interface 110 may be mounted onto the column 105 and is coupled to a controller (FIG. 2). A power head, also referred to as spindle motor, 115, is mounted onto the column 105, and may be fixed or movable at least in the Z-axis, as shown. The power head 115 may also be moved by numerical control in X, Y, i.e., translated horizontally, and θ, i.e., tilted from the vertical, as shown by the double-head arrows. A tool holder, 120 is mounted by a spindle 121 onto the power head 115 and is energized, e.g., rotated, by the power head 115. The rotation of the spindle 121 may be between about 7,000 rpm and 24,000 rpm, which generates high centrifugal forces. The tool holder 120 holds a machine tool 125, which contacts the workpiece to form the desired end product. The workpiece is held in place by a workpiece holder, e.g., a vise, 130, which is attached to the worktable or workbench 135. The worktable 135 is mounted onto the knee 145 via saddle 140. In embodiments, this arrangement may enable (but not mandatory) the workpiece to be translated in X, Y, rotated in r, and tilted in θ, directions by the numerical control. All of the motions of the power head and the workpiece may be performed simultaneously, which increases the possibility of collisions. Accordingly, in the embodiment of FIG. 1, collision sensor 150 is incorporated in the machine 100. Collision sensor 150 issues a collision signal wherever it senses that spindle 121 or tool holder 120 is in close proximity or collides with any part of machine 100 workpiece. In the various embodiments disclosed below, the collision sensor is designed to send signals to the controller to stop the operation of the machine in sufficient time to avoid damage to the tool or the workpiece. Therefore, the collision sensor is made either in the form of a proximity sensor or in the form of a contact sensor having sufficient margin to accept contact and stop the machine before occurrence of damage.

FIG. 2 schematically presents tool chuck arrangement 101 for avoiding a breakage of a processing facility. The tool chuck arrangement 101 may be used in the embodiment of FIG. 1, or any other CNC machine. Chuck arrangement 101 comprises sleeve 30 mounted onto tool chuck, tool holder, or spindle, collectively referred to as 10, and controller 33 connected to processing facility 35 to be stopped in an emergency. Tool chuck 10 holds rotationally operating tool 15. In the particular instance illustrated in FIG. 2, tool chuck 10 is displaced in horizontal direction 17, such that groove 25 within workpiece 20 is made. Member 27 refers to a portion of workpiece 20 potentially colliding with tool chuck 10.

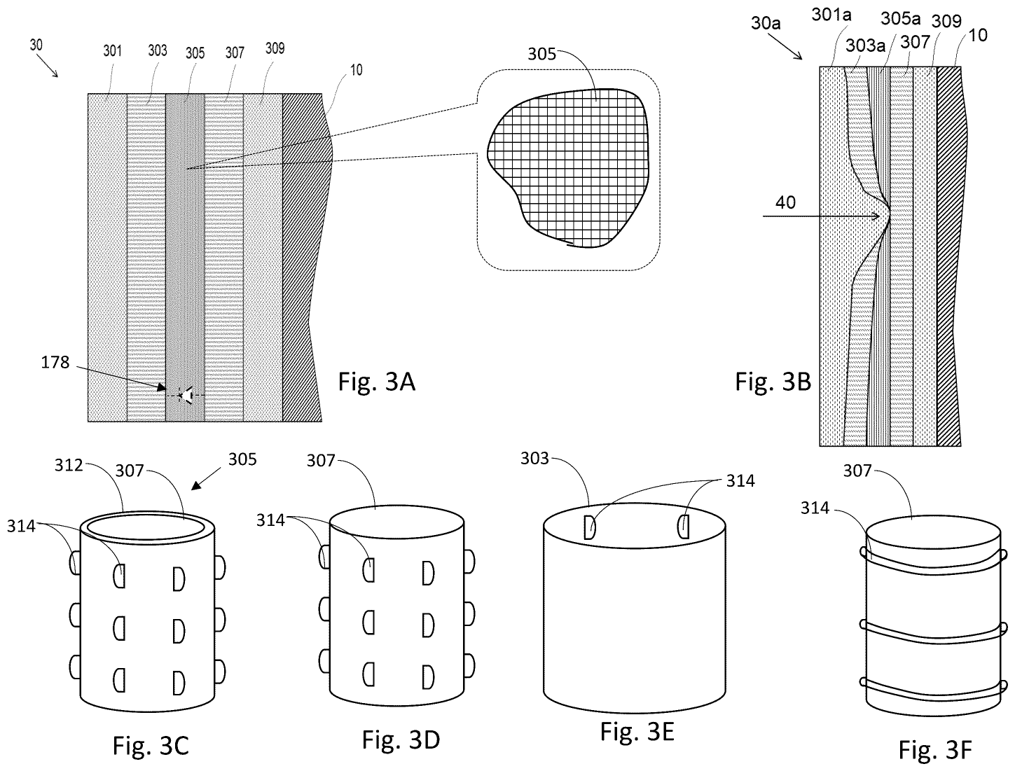

Reference is now made to FIGS. 3A and 3B schematically and in an-out of-scale manner presenting half-cross-sectional views of a sleeve mounted onto a tool chuck in normal and damaged positions, respectively. FIG. 3A shows sleeve 30 mounted onto tool chuck 10. Sleeve 30 has a multi-layered structure. Specifically, sleeve 30 comprises an inner electrically insulating layer 309 adjacent to and abating tool chuck 10, first and second electrically conductive layers 303 and 307, respectively and outer electrically insulating layer 301, which may be formed as a protective coating. Insulating layer 301 is configured for insulating conducting layer 303 from tools' environment and the workpiece. Insulating layer 309 is configured for insulating conductive layer 307 from tool chuck 10. Resilient insulation layer 305 is configured for normally maintain conductive layers 303 and 307 from contacting each other, e.g., due to centrifugal forces. Resilient insulation layer 305 applies resilient force to maintain conductive layers 303 and 307 separate from each other, however, the resilient force is designed so that it can be overcome when tool chuck 10 contacts an obstacle, so that an electric contact is made between layers 303 and 307. Such a collision situation is illustrated in FIG. 3B, wherein force 40 from mechanical impact overcomes the resiliency of layer 305a thereby causing layer 303a to contact layer 307. The contacting of conductive layers 303a and 307 is communicated to controller 33 (FIG. 2), which stops processing facility 35 (FIG. 2) in response to a circuit closure between conductive layers 303a and 307. Bent or indented sleeve 30a and layers 305a, 307 and 309 are schematically shown in FIG. 3B.

The inner electrically insulating layer 309 may be made of a non-slip material so as to avoid slippage and ensure rotation of the sleeve 30 with the tool chuck 10. Examples include anti-skid tape, neoprene rubber, a coating mixture of plasticizer, acrylic polymer and insoluble particles, wherein the particles may be silicate, aluminum oxide, etc. Alternatively, layer 309 may be mechanically affixed (by bolts, bands, etc.) to tool chuck 10 or adhered to tool chuck 10. The objective is to ensure that sleeve 30 rotates with, and does not slip over, tool chuck 10. However, it is desirable that sleeve 30 may be removable for replacement if damaged or malfunctioning.

As illustrated in the callout of FIG. 3A, resilient insulation layer 305 can be embodied as one or more electrically insulative mesh (including web, screen, etc.) of a resilient material, e.g., rubber, plastic, foam, polypropylene, polyethylene, nylon, PVC (polyvinyl chloride), PTFE (Polytetrafluoroethylene), etc. In the callout, an arbitrary portion of the mesh is illustrated in frontal view. While in the callout the holes between the strands are shown to be square, this is not necessary, and the strands can be configured to form any shape. Moreover, while in the callout the strands are placed in only two directions, “Manhattan” style (also referred to sometimes as rows and columns), so that each hole is defined by only four strands, other arrangements may be used including arrangements wherein the holes are defined by more than four strands. The holes themselves are sized so as to allow encroachment of layers 303 and 307 to enable contact between layers 303 and 307 upon application of predetermined force. Sizing of the holes also depends on the strength of the strands—the weaker the strands are, i.e., the easier it is to deform the strands, the smaller the holes may be. Conversely, the stronger the strands are, i.e., the harder it is to deform the strands, the larger the holes should be. However, in selecting the strength of the strands, i.e., the amount of resiliency, one needs to account for the centrifugal forces experienced by the sleeve during rotation of the tool holder, which may inadvertently cause layer 303 and 307 to contact each other.

FIG. 3C illustrates another embodiment of resilient insulating layer 305, which is formed of a cylindrical tube 312 having multitude of bumps 314 formed upon or attached thereto. In one example the cylindrical tube 312 is made of conductive material and the bumps are formed of insulative material, e.g., rubber, plastic, foam, polypropylene, polyethylene, nylon, PVC, PTFE, etc. In yet another example, illustrated in FIG. 3D, resilient insulative layer 305 is in the form of insulating bump 314 formed directly on or attached directly to the exterior of conductive layer 307. Conversely, in a further embodiment, illustrated in FIG. 3E, resilient insulative layer 305 is in the form of insulating bump 314 formed on or attached directly to the interior of conductive layer 303. In FIGS. 3C-E the bumps are shown as individual “mesas”, however this is not obligatory. For example, FIG. 3F illustrates an embodiment wherein the bumps are formed as rings around layer 307. In one example, the rings 314 are elastic O-rings.

As disclosed above, according to a disclosed aspect, a tool chuck protecting sleeve is provided, comprising: a sleeve (30) mountable on a tool chuck (10) configured for holding a milling cutter, the sleeve is having an internal portion facing the tool chuck and an opposite external portion (30A). The sleeve (30) comprises (a) a first, externally located, electrically insulating layer (301); (b) a first electrically conductive layer (303) provided in connection with the inner portion of the insulting layer (301); (c) a resilient insulating layer (305), provided in connection with the inner portion of the first electrically conductive layer (303); (d) a second electrically conductive layer (307), provided in connection with the inner portion of the resilient insulating layer (305); and (e) a second electrically insulating layer (309), provided in connection with the inner portion of the second electrically conductive layer (307).

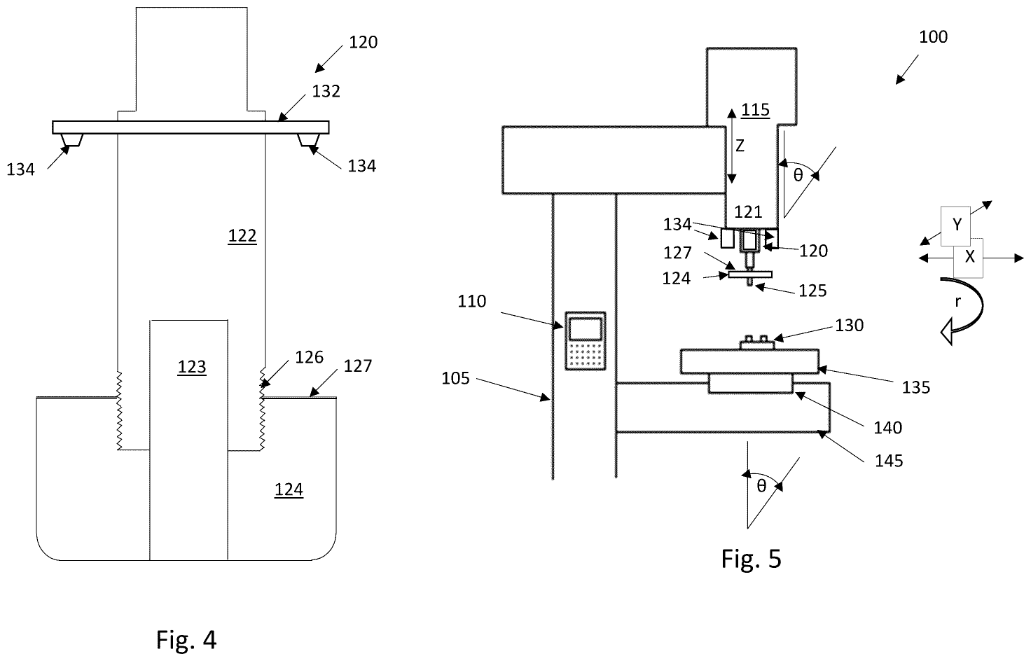

FIG. 4 illustrates a tool holder 120 according to another embodiment, which incorporates an example of a collision sensor implemented as a proximity sensor. Generally, tool holder has a main body 122 which includes a cavity 123 into which a shaft of the tool is inserted, and a collet nut 124 which is threaded onto thread 126 to secure the tool to the tool holder. In this embodiment, the upward facing surface 127 of the collet nut 124 is formed to be mirror-like, e.g., by polishing, coating, etc. Alternatively, a thin mirror-like disk is attached or adhered to the surface 127 or provided around the main body 122. Ring 132 is attached to or is formed integrally to the tool holder body 122. At least one pair 134 of light emitter and light sensor are attached to the ring 132, facing surface 127. The light emitter may be, e.g., light emitting diode (LED), diode laser, fiber optic cable, etc. The light sensor may be, e.g., photoresistors, photodiodes, phototransistors, etc.

For each pair of light emitter and light sensor, the light emitter shines a light beam onto the mirror-like surface 127, and the light sensor detects light reflected from the mirror-like surface 127. When the tool holder approaches an obstacle, the light reflection would be interrupted, thus indicating an unallowed movement of the CNC machine. Note that due to the high rotational speed of the tool holder, in principle it is sufficient to have a single pair of light emitted and light sensor. However, due to the high rotational speed it is also preferred to have the tool holder balanced, and hence rotationally symmetrical. Therefore, a number of pairs of light emitted and light sensors may be provided on the ring, positioned to have rotational symmetry. For example, if two pairs are used, they should be spaced 1800 apart, if four pairs are used, they should be spaced 900 apart, if six pairs are used, they should be spaced 600 apart, etc.

According to yet another embodiment, illustrated in FIG. 5, the tool holder 120 includes the collet nut 124, which has the mirror-like upward facing surface 127, or incorporates a mirrored ring around its body. A plurality of pairs of light emitters and light sensors are provided on a non-rotating part of the CNC machine, e.g., at a bottom facing surface of the power head 115. Each of the pairs 134 is positioned to shine a light beam onto surface 127 and to detect light reflected from surface 127. Note, however, that since the pairs 134 are attached to a non-rotating part of the machine, it is recommended to use a plurality of pairs 134 positioned concentrically about the rotational axis of the tool holder 120.

Incidentally, in this disclosure, when reference is made to a plurality of light emitters, it includes a plurality of light sources, such as light emitting diodes (LED), diode lasers, etc., or to an arrangement wherein a single light source is used and the emitted light is split into a plurality of light conduits, such as fiber optics cables, to thereby generate a plurality of light emitters from a single light source.

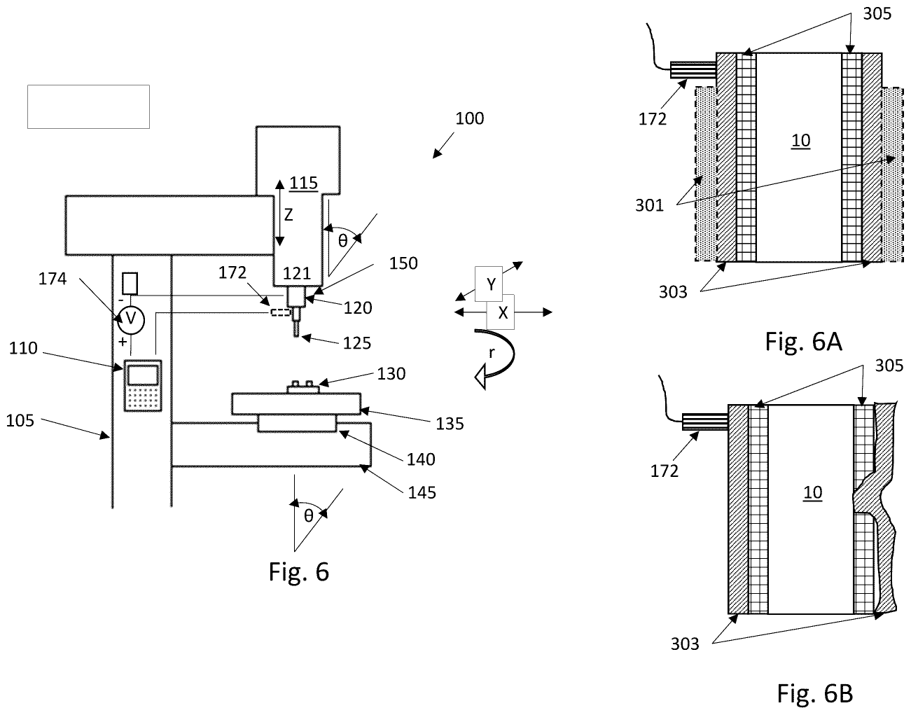

FIG. 6 illustrates yet another embodiment having a collision sensor 150 mounted onto the tool holder and sending collision signals to the machine controller 33 (FIG. 2) coupled to the machine interface 110. A cross-section of the collision sensor 150 mounted onto the tool holder 10 is illustrated in FIG. 6A. In this example the collision sensor 150 is made of two layers: resilient insulation layer 305 is formed or mounted onto the exterior surface of tool holder 10, and conductive layer 303 is provided about the resilient insulation layer 305. Both layers 303 and 305 are formed as concentric cylinders or cylindrical planes. That is, when resilient insulation layer 305 is formed as bumps or rings (see, e.g., FIGS. 3D and 3F), they define cylindrical planes and the conductive layer 303 is concentric with that plane.

In the embodiment of FIG. 6, a low voltage potential, e.g., a 5 volt DC potential, from a voltage supplier 174 (which may be part of controller 33), has its positive side coupled to the controller 33 and its ground (negative) side coupled to the tool holder 10, so that with respect to the low voltage, the tool holder 10 is grounded. As illustrated in FIG. 6, and more clearly shown in FIG. 6A, a brush contact 172 contacts conductive layer 303 of the collision sensor 150, and has its output coupled to the controller 33. Under normal operating conditions, conductive layer 303 is maintained at a floating potential with respect to the low voltage and, accordingly, the low voltage circuit is open. As illustrated in FIG. 6B, upon collision, conductive layer 303 deforms and presses against resilient insulation layer 305, so as to contact tool holder 10. Since tool holder 10 is at ground potential with respect to the low voltage, layer 303 closes the low voltage circuit by coupling the brush contact 172 to the ground potential. The machine controller 33 now senses that the circuit has been closed, which indicates collision, and takes a predetermine measure, such as stopping the movement of tool holder 10 and/or issuing an alarm. Optionally (dashed line indicates an optional element), if desired, a protective insulating layer 301 may be provided over conductive layer 303, provided that it leaves an exposed part for the brush contact 172 to contact conductive layer 303.

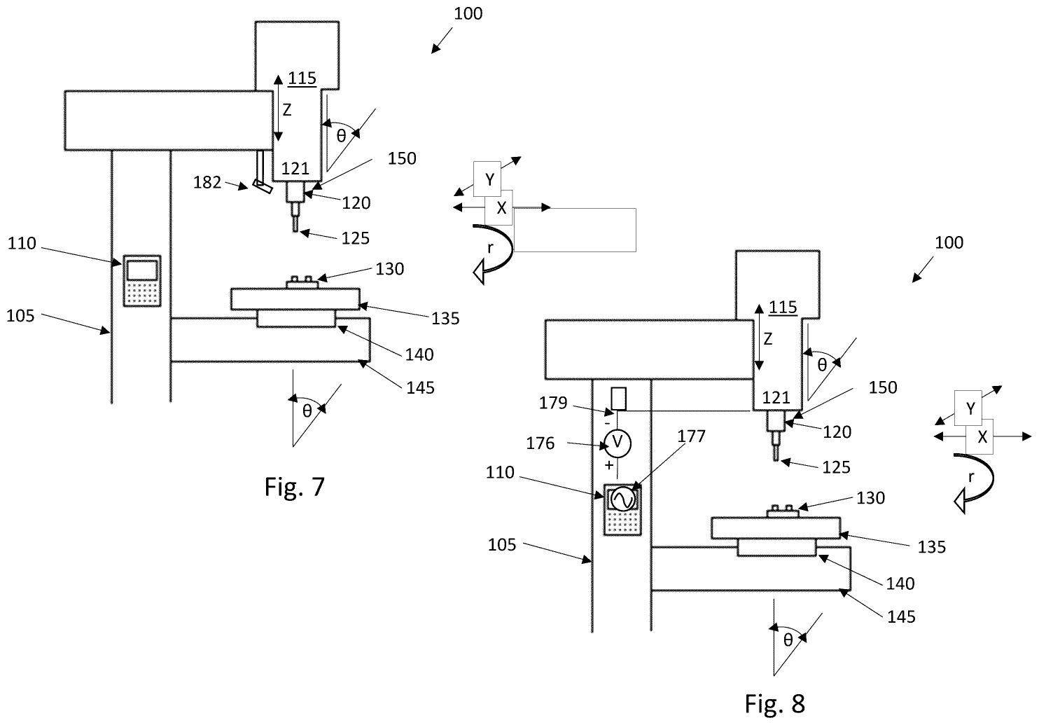

FIG. 7 illustrates yet another embodiment of a CNC machine incorporating a collision sensor. In the embodiment of FIG. 7, the collision sensor is in the form of a thermometer (temperature sensor) 182. In the illustrated example thermometer 182 is a contactless thermometer, but resistive or contact thermometers may also be used. As noted, tool holder 120 rotates at a high rotational speed. When tool holder contacts an object, due to friction at the contact point the temperature of the tool holder increases. Therefore, thermometer 182 measures the temperature of tool holder 120 and periodically sends its reading to controller 33. Controller 33 determines whether a change in the temperature reading indicates a collision. To avoid false readings, controller 33 utilizes averaging methods or rate of change methods. For example, controller 33 may compare a current reading to average of n number of prior readings to determine if the difference surpasses an allowable difference threshold. Alternatively, or in addition, controller 33 calculates a differential of the temperature reading to determine the rate of change of the temperature of tool holder 120 surpasses an allowable rate threshold.

In disclosed embodiments, the collision sensor may be provided as an add-on item that is attached to the tool holder. The attachment may be permanent or removable to enable replacement upon damage or malfunction of the collision sensor. In other embodiments, the collision sensor is integrated with the tool holder, such that it forms an integral part of the tool holder and/or the CNC machine. In the disclosed embodiments the collision sensor in essence monitors the tool holder or its motion and issues a collision signal to the controller indicating potential collision of the tool holder with an object.

According to another embodiment, a tool chuck protecting sleeve and collision sensor system is disclosed, comprising: a sleeve (30) mountable on an exterior cylindrical surface of the tool chuck (10), the tool chuck being configured for holding a milling cutter, the sleeve having an internal portion facing the tool chuck and an opposite external portion (30A); the sleeve (30) comprises a resilient insulation layer (305) provided about the tool chuck (10), and a first electrically conductive layer (303) provided over and concentric with the resilient insulation layer; and a controller configured for stopping motion of the tool chuck (10) upon receiving a collision signal from the sleeve, the controller being electrically-interconnected with the first electrically conductive layer (303). The sleeve (30) may further include an inner electrically insulating layer (309) provided in contact with the tool chuck 10; a protective layer (301) provided over the first electrically conductive layer 303; and a second electrically conductive layer (307) provided between the inner electrically insulating layer (309) and the resilient insulation layer (305).

The disclosure also provides a computer-numerical-control (CNC) machine, comprising: a power head (115); a tool holder (120) rotationally coupled to the power head; a workbench (135); a controller (33) coupled to the power head and energizing the powerhead to spin the tool holder, the controller further controlling spatial movement of at least one of the powerhead and the workbench; a collision sensor provided about the tool holder and sending collision signal upon sensing an imminent collision of the tool holder with an object. The collision sensor may incorporate at least one pair of light emitter and light sensor, the light emitted shining a light beam onto a mirrored surface and the light sensor sensing light reflected from the mirrored surface. The collision sensor may incorporate a thermal sensor (182) sending temperature readings of the tool holder to the controller (33). The collision sensor may be embodied in a tool chuck protecting sleeve, comprising: (a) a sleeve (30) mountable on a tool holder (10), the sleeve is having an internal portion facing the tool holder and an opposite external portion (30A); the sleeve (30) comprises (i) a first, externally located, electrically insulating layer (301a); (ii) a first electrically conductive layer (303a) provided in connection with the inner portion of the insulting layer (301a); (iii) a resilient insulation layer (305a), provided in connection with the inner portion of the first electrically conductive layer (303a); (iv) a second electrically conductive layer (307), provided in connection with the inner portion of the resilient insulation layer (305a); and (v) a second electrically insulating layer (309), provided in connection with the inner portion of the second electrically conductive layer (307).

The controller is operatable in a method comprises steps as follows: (a) along a safe milling, the resilient insulation layer (305a) continuously insulating the first (301a) and second (307) electrically conductive layers from each other; and (b) upon an externally applied mechanical impact (40) provided via (1) the first electrically insulating layer (301a), (2) the first electrically conductive layer (303a), and (3) resilient insulation layer (305a), the first electrically conductive layer (303a) is contacting the second (307) electrically conductive layer; thereby closuring a circuit between the first and second electrically conductive layers and signaling interconnected controller for stopping the milling operation.

According to a further embodiment of the invention, a method of alarming or otherwise avoiding a breakage of a milling operation is disclosed. The method is characterized by steps of providing tool chuck protecting sleeve system; characterized by (a) mounting or otherwise integrating a tool chuck (10) configured for holding a milling cutter with a tool chuck protecting sleeve (30) having an internal portion facing the tool chuck and an opposite external portion (30A); (b) by means of the milling cutter provided within a tool chuck protecting sleeve, safely milling; the resilient insulation layer (305a) continuously insulating the first (301a) and second (307) electrically conductive layers from each other; and (b) upon applying an externally mechanical impact (40) provided via the first electrically insulating layer (301a), (2) the first electrically conductive layer (303a), and (3) resilient insulation layer (305a), connecting the first electrically conductive layer (303a) with the second (307) electrically conductive layer; thereby closuring a circuit between the first and second electrically conductive layers and signaling interconnected controller for stopping the milling operation.

Various embodiments disclosed herein involve a sensor that is mounted onto a rotating element of a machine, e.g., on a tool holder or spindle. Various implementations may be employed in order to obtain a signal from the rotating sensor, as illustrated in disclosed embodiments. FIG. 2 illustrates an optional wireless transmitter 12, which is coupled to the contacts of the sensor (e.g., the conductive layers). In disclosed embodiments the wireless transmitter is mounted onto the tool holder, the spindle, or forms part of the sensor. In some embodiments the wireless transmitted is self-powered by including a power source such as a battery, dynamo, generator, etc. The wireless transmitted communicates with a corresponding receiver 13, which may be part of the controller 33 or be communicating with controller 33, using any wireless signal transmission methods, such as frequency modulation (FM), infrared (IR), radio frequency (RF), Bluetooth, WiFi, microwave, light, acoustic signaling, etc.

Accordingly, the disclosure also provides a computer-numerical-control (CNC) machine, comprising: a power head (115); a tool holder (120) rotationally coupled to the power head; a workbench (135); a controller (33) coupled to the power head and energizing the powerhead to spin the tool holder, the controller further controlling spatial movement of at least one of the powerhead and the workbench; a collision sensor provided about the tool holder; a wireless transmitter coupled to the collision sensor and wirelessly transmitting a collision signal upon detection of collision by the collision sensor; and a wireless receiver communicating with the wireless transmitted and relaying the collision signal to the controller.

According to other embodiments, rather than (or in addition to) using wireless transmission, communication with the sensor is done via the tool holder itself. The tool holder is made of conductive material and can be used to send or receive signals from the sensor by electrically connecting the sensor to the tool holder. Such embodiments, implement a “single-wire” communication mechanism. According to these embodiments, a computer-numerical-control (CNC) machine is provided, comprising: a power head (115); a tool holder (120) rotationally coupled to the power head; a workbench (135); a controller (33) coupled to the power head and energizing the powerhead to spin the tool holder, the controller having electrical path to the tool holder, the controller further controlling spatial movement of at least one of the powerhead and the workbench; a collision sensor provided about the tool holder, the collision sensor having electrical contact to the tool holder, the electrical path and the electrical contact forming communication link between the controller and the collision sensor. Various embodiments to implement such an arrangement are described below.

According to other embodiments, illustrated in FIG. 8, a signal is applied to the sensor from a signal generator 176 (which may be part of the controller 33) and a response is measured by measuring circuit 177 (which may also be part of the controller 33). In FIG. 8 the signal generator 176 is shown in an arbitrary position on a communication path 179 between the controller and the tool holder. This is intended to signify a few features of the embodiments described below. A first feature, as noted above, is the sensor having electrical contact to the tool holder, so that the tool holder is used as a communication link. Specifically, the electrical path of the controller and the electrical contact of the sensor forms a communication link between the controller and the collision sensor for transfer of electrical signals. The second feature is the utilizing of the tool holder as a single-strand communication link, thus implementing single strand communication protocols and arrangements. The third feature is that the placement of the signal generator 176 can be either on the collision sensor, in the controller, or placed independently along the communication path. A fourth feature is that the signal generator can be used to generate a signal that is applied to the collision sensor for detecting a collision, and to send a collision signal to the controller via the communication path. Thus, in the following descriptions it should be understood that any disclosed embodiment may be implemented as having the signal generator integrated with the collision sensor, with the controller, or being independently placed on the communication path.

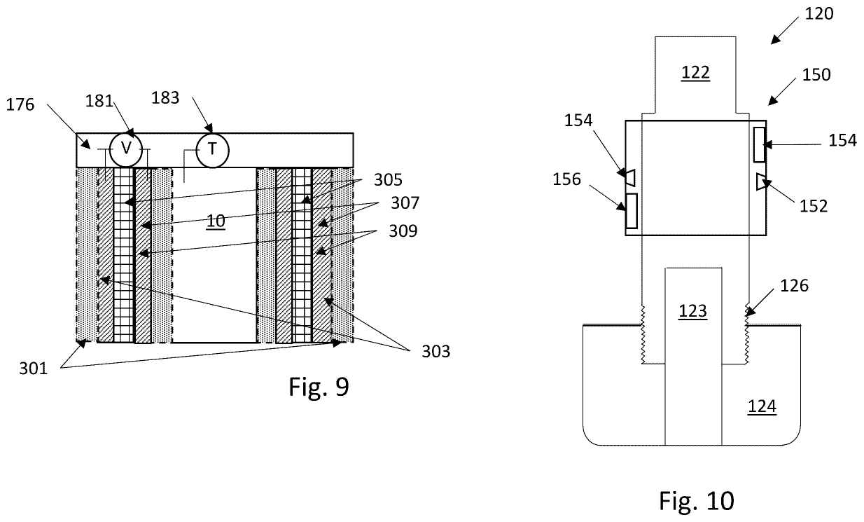

For example, FIG. 9 illustrates an embodiment wherein the signal generator 176 is integral to the collision sensor. While various implementations will be detailed below, in this specific example the signal generator has a signal applicator 181 applying a signal to the two conductive layers 303 and 307, and a communicator 183 transceiving communication signals with the controller via an electrical contact to the tool holder 10.

According to a first embodiment, measuring circuit 177 measures an electrical resistance of the collision sensor. A normal resistance would be measured and recorded when no collision occurs and is used as comparison value to a resistance detected during machine operation. When a measured resistance deviates from the normal resistance, a collision signal is issued by the controller 33.

According to another embodiment, also exemplified in FIG. 8, the measuring circuit measures voltage potential. According to this embodiment the signal generator 176 applied a voltage potential (which may be ground) to one of the conductive layers of the collision sensor. Upon collision the measuring circuit 177 would detect a change in the voltage value and would send a collision signal to the controller 33.

In the embodiments wherein two concentric conductive layers are used for the sensor, they in fact form a capacitor. Thus, when signal generator 176 applies voltage potential to one of the conductive layers, it will charge the capacitor and the measuring circuit 177 may measure the sensed capacitance on the sensor. However, upon collision, when the two conductive layers make electrical contact or change their relative spatial orientation, the capacitor would be discharged or the capacitance value would change, and the sensing circuit would detect this change in capacitance value and send a collision signal to the controller 33.

According to yet another embodiment, signal generator 176 applies a voltage potential to one of the conductive layers of the collision sensor. The measuring circuit is configured as a current sensor. Under normal operating conditions, the two conductive layers are insulated from each other, such that no electrical current flows between them. However, when the conductive layers contact each other upon collision, current would flow from one conductive layer to the other, and the measuring circuit would detect the current flow and issue a collision signal to the controller 33. In a similar manner, signal generator 176 may be configured as a pulse generator and send pulses to the collision sensor. For example, when the pulse generator is provided in the controller or elsewhere on the electrical path 179, the pulses can be sent to the sensor via the tool holder. The measuring circuit 177 is formed as a pulse counter and detects change in pulse count as indicative as collision.

In disclosed embodiments wherein the collision sensor in essence forms a switch that closes upon collision, the sensor may form part of an LC (inductor capacitor) circuit. The resonance of the circuit changes depending on whether the sensor forms an open or closed switch state. In such embodiments, the measuring circuit 177 measures resonance frequency. In some examples the signal generator 176 sends a range of frequencies to the sensor and the measuring circuit 177 analyzes which frequency resonates in the LC circuit.

In yet further example, the signal generator 176 and measuring circuit 177 are implemented to perform time-domain reflectometry (TDR). The signal generator 176 generates and sends pulses to the collision sensor. The measuring circuit 177 measures reflected pulses from the sensor. The measuring circuit 177 would issue a collision signal upon detecting change in the reflection characteristics of the pulses. Alternatively, the signal generator 176 applies current to the sensor, whereupon a magnetic field is generated about the conductive layer. The measuring circuit may incorporate a magnetometer or a hall effect sensor to measure changes in the generated magnetic field.

In yet further embodiment, a diode 178 is coupled between the two conductive layers, as illustrated in FIG. 3A. Signal generator 176 sends pulses of alternative electrical polarity to the sensor. As the diode 178 allows pulses of only one electrical polarity to pass, measuring circuit 177 detects collision by sensing the pulses.

Thus, in disclosed embodiments, a computer-numerical-control (CNC) machine is provided, comprising: a power head (115); a tool holder (120) rotationally coupled to the power head; a workbench (135); a controller (33) coupled to the power head and energizing the powerhead to spin the tool holder, the controller further controlling spatial movement of at least one of the powerhead and the workbench; a collision sensor provided about the tool holder; a signal generator sending check signals to the collision sensor; and a measuring circuit measuring response of the collision sensor to the check signals.

A proximity sensor is a sensor able to detect the presence of nearby objects without any physical contact. FIGS. 5 and 6 illustrate embodiments wherein a non-contact proximity sensor is utilized for the collision sensor. However, there are other options for utilizing proximity sensors. For example, proximity sensor often emits an electromagnetic field or a beam of electromagnetic radiation (infrared, for instance), generates a magnetic field, issues acoustic beam, etc., and looks for changes in the field or return signal. Generally proximity sensors have been installed in a stationary part of an object, e.g., a collision sensor in a bumper of a car, wherein the bumper is stationary with respect to the body of the car. FIG. 10, on the other hand, illustrates utilizing a proximity sensor on a rotating part, i.e., the tool holder.

In FIG. 10, collision sensor 150 is installed on the rotating tool holder 120. The collision sensor 150 incorporates at least one proximity sensor 152. Since the tool holder rotates at relatively high speeds the single proximity sensor would scan 360° around the tool holder at a rapid rate and be able to detect potential collision at any direction. In FIG. 10 two proximity sensors are shown to illustrate that the number of proximity sensors can vary. In this embodiment, the collision sensor also include a power source 154, e.g., a battery or other power source, and a signal transmitter 156. The signal transmitter 156 may be wireless transmitted as described above. Alternatively it may transmit signals via the tool holder using the single strand methods also described above.

Additional advantages and modifications may be clearly added to the present invention without departing from the scope of the present invention. Although the present invention has been shown and described with respect to what is considered to be the most practical and preferred embodiment, it is recognized that departures may be made from that embodiment within the scope and spirit of the invention. It is not intended to be limited to the details disclosed in the specification, but is to be given the full scope of the appended claims to encompass any equivalent devices and apparatus.

In an embodiment of the invention, the sleeve or a portion thereof is flexible. Alternatively, or additionally, the sleeve or a portion thereof is semi-flexible. Alternatively, or additionally, the sleeve is a standalone article of manufacture. Alternatively, or additionally, the sleeve comprises two or more interconnected or interrelated or interconnected modules. Furthermore, within this disclosure the term sleeve is intended to also include various forms of encapsulation of coatings on the tool holder itself. That is, the various insulative and conductive layers of the sleeve may be formed by coating the tool holder with various insulative and conductive coating materials.

Alternatively, or additionally, the sleeve is of radial or curved cross section, and comprises one layer; or otherwise, two or more interconnected or interrelated or interconnected layers. In an embodiment of the invention, the outermost layer or surface is insulated. In another embodiment of the invention, the outermost layer or surface is conductive and close a circuit with the raw material. In another embodiment the sleeve-like sensor comprises a tool holder that closes a circuit with raw material. In another embodiment of the invention an inner layer is insulated from the outer conductive layer, but it made of conductive material for communication with the machine's controller.

It is well in the scope of the invention wherein the terms further refer to at least one members of a group consisting of chuck, tool holders, bits arrangements or bits holders, shrink fit holders, machine tables, work-holding fixtures such as clamps, vises, jigs, vacuum tables, movable parts, such as printing head, CNC head, probes and probing head, axles, shafts, hinges, pivots and other article of manufacture. The term chuck is used herein to refer not only to collets, but also to other clamps used to hold an object with approximate radial symmetry. The term “milling” refers hereinafter to operating said tool and/or holder thereof.

What is claimed is:

1. A protective sleeve mountable on a tool holder configured for holding a milling cutter, said protective sleeve having an internal portion facing said tool holder and an opposite external portion; said sleeve comprising:
a. a first electrically insulating layer;
b. a first electrically conductive layer provided concentrically with the inner portion of said first electrically insulting layer;
c. a resilient insulating layer provided concentrically with the inner portion of said first electrically conductive layer; and
d. a second electrically conductive layer, provided concentrically with the inner portion of said resilient insulating layer.

2. The protective sleeve of claim 1, further comprising a second electrically insulating layer, provided concentrically with the inner portion of said second electrically conductive layer

3. The protective sleeve of claim 1, wherein said resilient insulating layer comprises one of: an insulative mesh, a plurality of bumps formed of insulative material, or a plurality of rings formed of insulative material.

4. The protective sleeve of claim 1, further comprising a wireless transmitter electrically coupled to at least one of the first electrically conductive layer and second electrically conductive layer.

5. The protective sleeve of claim 1, further comprising a diode coupled between the first electrically conductive layer and the second electrically conductive layer.

6. A tool holder for a computer numerical control machine, comprising:
a. a tool holder body having exterior cylindrical surface;
b. a sleeve mounted on the exterior cylindrical surface of the tool holder, the sleeve comprises a resilient insulation layer provided around the exterior cylindrical surface of the tool holder, and an exterior electrically conductive layer provided over and concentric with the resilient insulation layer; wherein the exterior electrically conductive layer is electrically-interconnected with a controller configured for stopping motion of the tool holder upon receiving a collision signal from the exterior electrically conductive layer.

7. The tool holder of claim 6, wherein the resilient insulating layer comprises one of: an insulative mesh, a plurality of bumps formed of insulative material, or a plurality of rings formed of insulative material.

8. The tool holder of claim 7, further comprising a brush contact electrically contacting the exterior electrically conductive layer.

9. The tool holder of claim 7, further comprising a wireless transmitter electrically coupled to the exterior electrically conductive layer.

10. A computer numerically controlled (CNC) machine, comprising:
a. a power head mounted on a base;
b. a tool holder rotationally mounted onto the power head;
c. a controller;
d. a collision sensor detecting potential collision of the tool holder with an object and issuing a collision signal to the controller indicating the potential collision of the tool holder.

11. The CNC machine of claim 10, wherein the collision sensor comprises a mirrored surface provided on the tool holder and at least one pair of light emitter and light sensor, the light emitter shining a light beam on the mirror surface and the light sensor detecting reflected light from the mirror surface.

12. The CNC machine of claim 11, wherein the at least one pair of light emitter and light sensor is mounted onto the power head.

13. The CNC machine of claim 11, wherein the at least one pair of light emitter and light sensor is mounted onto the tool holder.

14. The CNC machine of claim 11, wherein the light emitter comprises a light source and at least one fiber optic cable.

15. The CNC machine of claim 10, further comprising a wireless transmitter electrically coupled to the collision sensor and wirelessly transmitting the collision signal to the controller.

16. The CNC machine of claim 10, wherein the collision sensor comprises a temperature sensor sending temperature reading indicative of collision of the tool holder to the controller.

17. The CNC machine of claim 10, wherein the collision sensor comprises a sleeve mounted onto the tool holder, the sleeve comprising a resilient insulation layer provided around the exterior cylindrical surface of the tool holder, and an exterior electrically conductive layer provided over and concentric with the resilient insulation layer; wherein the exterior electrically conductive layer is electrically-interconnected with a controller configured for stopping motion of the tool holder upon receiving a collision signal from the exterior electrically conductive layer.

18. The CNC machine of claim 17, wherein the resilient insulating layer comprises one of: an insulative mesh, a plurality of bumps formed of insulative material, or a plurality of rings formed of insulative material.

19. The CNC machine of claim 17, further comprising a brush contact electrically contacting the exterior electrically conductive layer.

20. The CNC machine of claim 17, further comprising a signal generator sending check signals to the collision sensor and a measuring circuit measuring response of the collision sensor to the check signals.

21. The CNC machine of claim 20, wherein the check signals comprise a voltage potential, an electrical current, electrical pulses, or variable frequency signal.
